(19) United States
(12) Patent Application Publication
(10) Pub. No.: US 2016/0291401 A1
(43) Pub. Date: Oct. 6, 2016

(54) FLEXIBLE LIQUID CRYSTAL PANEL AND MANUFACTURING METHOD THEREOF

(71) Applicants: BOE TECHNOLOGY GROUP CO., LTD., Beijing (CN); CHENGDU BOE OPTOELECTRONICS TECHNOLOGY CO., LTD., Chengdu, Sichuan (CN)

(72) Inventors: Shi Cheng, Beijing (CN); Tianlei Shi, Beijing (CN)

(73) Assignee: BOE Technology Group Co., Ltd., Beijing (CN)

(21) Appl. No.: 14/769,249

(22) PCT Filed: Aug. 28, 2014
(86) PCT No.: PCT/CN2014/085414

§ 371 Date: Aug. 20, 2015

(30) Foreign Application Priority Data
Apr. 30, 2014 (CN) 201410183651.9

(51) Int. Cl. G02F 1/1335; G02F 1/1333; G02F 1/1341; G02F 1/1339

(52) U.S. Cl. CPC G02F 1/133514; G02F 1/1339; G02F 1/133305; G02F 1/133512; G02F 1/1341

(57) ABSTRACT

The present invention relates to the field of display technology, and more particularly, to a flexible liquid crystal panel and a manufacturing method thereof. The flexible liquid crystal panel comprises a color filter substrate, an array substrate and a liquid crystal layer which is interposed between the color filter substrate and the array substrate. The color filter substrate includes a color filter layer which has a plurality of sub-filter elements. The liquid crystal layer comprises a plurality of separated liquid crystal boxes which are defined by sealing frames, and each of the liquid crystal boxes is arranged in correspondence with at least one sub-filter element. The sealing frames form the frames of the crystal boxes. In present invention, a plurality of separated liquid crystal boxes are provided in the liquid crystal layer, each of the liquid crystal is arranged in correspondence with at least one sub-filter element, such that the liquid crystal panel can display correctly when being bent, which solves the problem of interfere between the sub-pixels when a flexible displaying a performed and improves the display effect of the flexible liquid crystal panel.

### CROSS-REFERENCE TO RELATED APPLICATION

This application claims the benefit of Chinese Patent Application No. 201410183651.9 filed on Apr. 30, 2014 in the State Intellectual Property Office of China, the whole disclosure of which is incorporated herein by reference.

1. Field of the Invention

Embodiments of the present invention relate to the field of display technology, and more particularly to a flexible liquid crystal panel and a manufacturing method thereof.

2. Description of the Related Art

A liquid crystal panel being used currently, as shown in FIGS. 1 and 2, comprises a color filter substrate 1, an array substrate 2 and a liquid crystal layer interposed between the color filter substrate 1 and the array substrate 2. The color filter substrate 1 and the array substrate 2 are assembled together in vacuum environment with a sealing frame 5. Liquid crystal 4 can be regarded as being provided in a hollow liquid crystal box, with the periphery of the liquid crystal box is sealed by the sealing frame. A spacer 3 is provided in the liquid crystal layer for supporting the color filter substrate 1 and the array substrate 2, so as to form a space for the liquid crystal layer. As shown in FIG. 3, a red sub-filter element 10, a green sub-filter element 11 and a blue sub-filter element (not shown in the Figure) are spaced apart and shielded from each other by a black matrix 6.

The top and bottom side of the liquid crystal layer are provided with a common electrode 8 and a pixel electrode 9 corresponding to each other, the liquid crystal layer may be divided into liquid crystal 42 outside the electrode region and liquid crystal 41 inside the electrode region. The black matrix 6 is able to prevent light leakage from the liquid crystal 42 outside the electrode region, and to avoid light interference between sub-pixels. However, when the flexible liquid crystal panel performing display, the liquid crystal corresponding to respective sub-filter elements are not independent to each other. Due to the gap inside the liquid crystal box of the liquid crystal panel, the liquid crystal layer is prone to light leakage, and the sub-filter elements are prone to interference with each other when the liquid crystal panel is bended or viewed from a side.

### SUMMARY OF THE INVENTION

The present invention has been made to overcome or alleviate light leakage of the liquid crystal panel and mutual interference between the sub-pixels.

According to an aspect of embodiments of the present invention, there is provided an flexible liquid crystal panel comprises a color filter substrate, an array substrate and a liquid crystal layer interposed between the color filter substrate and the array substrate. The color filter substrate includes a color filter layer which has a plurality of sub-filter elements. The liquid crystal layer comprises a plurality of separated liquid crystal boxes defined by the sealing frames, and each of the liquid crystal boxes is arranged so as to correspond to at least one sub-filter element, the sealing frames fauns the frames of the liquid crystal boxes.

Alternatively, the color filter layer of the color filter substrate further comprises a black matrix which separates the plurality of sub-filter elements; and the positions of the frames of the liquid crystal boxes correspond to those of the frames of the black matrix.

Further, the sealing frame comprises a black light-blocking material. Further, the frame of each liquid crystal box corresponds to the position of the black matrix, and the planar pattern of the liquid crystal boxes is same as that of the black matrix.

Alternatively, the sealing frame comprises a black light-blocking material, and forms a black matrix which separates the plurality of the sub-filter elements.

In the above flexible liquid crystal panel, alternatively, the sealing frame forms a spacer between the color filter substrate and the array substrate.

In the above flexible liquid crystal panel, alternatively, the sealing frame at the edge of the flexible liquid crystal panel forms a box assembling frame, while the sealing frame inside the flexible crystal panel forms a pixel frame, the box assembling frame has a width larger than that of the pixel frame.

According to another aspect of the embodiments of the present invention, there is provided a method of manufacturing a flexible liquid crystal panel, which comprises steps of

defining a plurality of separated liquid crystal boxes on a color filter substrate or an array substrate and forming frames of the liquid crystal boxes with sealing frames , each liquid crystal box being arranged in correspondence with at least one sub-filter element;

injecting liquid crystal material into the liquid crystal boxes;

assembling the color filter substrate and the array substrate after liquid crystal material is injected into the liquid crystal boxes.

Optionally, forming the sealing frame on the color filter substrate directly, specifically, forming a plurality of separated liquid crystal boxes on the color filter substrate enclosed by the sealing frame, and the step of forming a plurality of separated liquid crystal boxes on the color filter substrate enclosed by the sealing frame comprises: forming a sealing frame film layer on the color filter substrate; forming a pattern of frames of the plurality of liquid crystal boxes in the sealing frame film layer by a patterning process, the pattern of the frames of each liquid crystal box is arranged in correspondence with at least one sub-filter element. Further, a color filter layer is provided on the color filter substrate, the color filter layer comprises a plurality of sub-filter elements and a black matrix which separates the plurality of sub-filter elements; and the pattern of the frames of the plurality of the liquid crystal boxes is provided on the color filter layer and the pattern of the frames of the plurality of the liquid crystal boxes is arranged along the pattern of the black matrix correspondingly. Alternatively, the sealing frame comprises a black light-blocking material. Alternatively, the sealing frame comprises a black light-blocking material. Or alternatively, the sealing frame forms the black matrix on the color filter substrate directly, specifically, a color filter layer which comprises multiple sub-filter elements is provided on the color filter substrate; the sealing frame comprises a black light-blocking material; and the frames of the liquid crystal boxes form the black matrix which separates the sub-filter elements.

The sealing frame may also forms on the array substrate directly. Specifically, forming a plurality of separated liquid crystal boxes on the array substrate enclosed by the sealing frame, and the step of forming a plurality of separated liquid crystal boxes on the array substrate enclosed by the sealing frame comprises: forming a sealing frame film layer on the array substrate; forming a pattern of the frames of the plurality of liquid crystal boxes in the sealing frame film layer by a patterning process, the pattern of the frame of each liquid crystal box is arranged to correspond to the interval between the sub-filter elements. Alternatively, the sealing frame comprises a black light-blocking material. The sealing frame may form the black matrix, specifically, the frames of the liquid crystal boxes form the black matrix which separates the sub-filter elements.

In the above method, the step of assembling the color filter substrate and the array substrate comprises: performing a hot pressing process on the liquid crystal box to bond the color filter substrate and the array substrate together so as to form a liquid crystal panel. In the above method, the step of injecting liquid crystal material into the liquid crystal boxes comprises injecting liquid crystal material into each of the liquid crystal boxes by an ink jet printing process.

### BRIEF DESCRIPTION OF THE DRAWINGS

FIG. 1 is a sectional view of a liquid crystal panel in the art;

FIG. 2 is a plan view of a liquid crystal panel in the art;

FIG. 3 is a sectional view showing the inner structure of a liquid crystal panel in the art;

FIG. 4 is a vertical sectional view of a flexible liquid crystal panel according to a first exemplary embodiment of present invention;

FIG. 5 is a horizontal sectional view of the color filter substrate according to the first exemplary embodiment of present invention;

FIG. 6 is a vertical sectional view of the flexible liquid crystal panel according to the first exemplary embodiment of present invention after a step S2 of a manufacture process; FIG. 7 is a vertical sectional view of the flexible liquid crystal panel according to the first exemplary embodiment of present invention after a step S3 of the manufacture process;

FIG. 8 is a partial vertical sectional view of a flexible liquid crystal panel according to a second exemplary embodiment of present invention; and

FIG. 9 is a vertical sectional view of the flexible liquid crystal panel according to the second exemplary embodiment of present invention after a step S20 of a manufacture process.

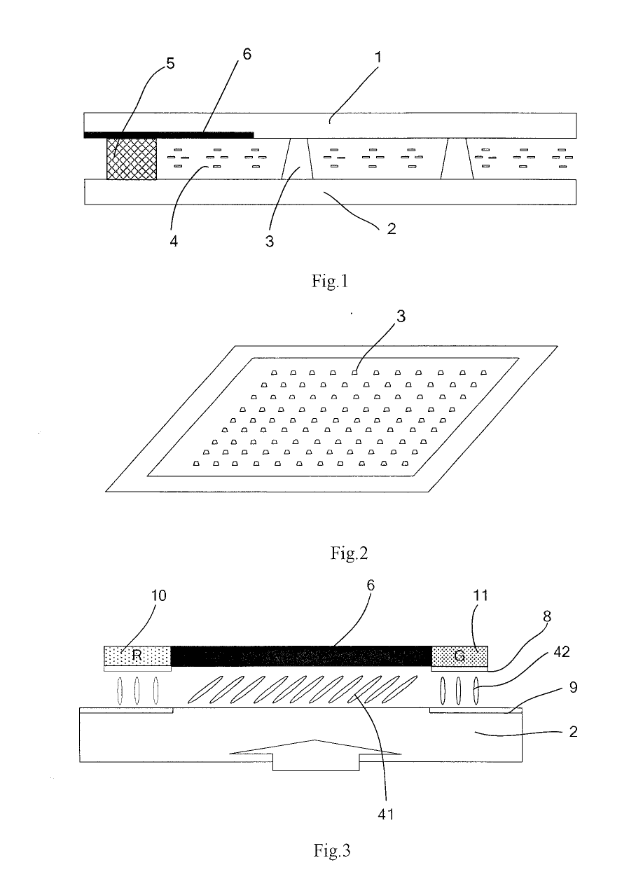

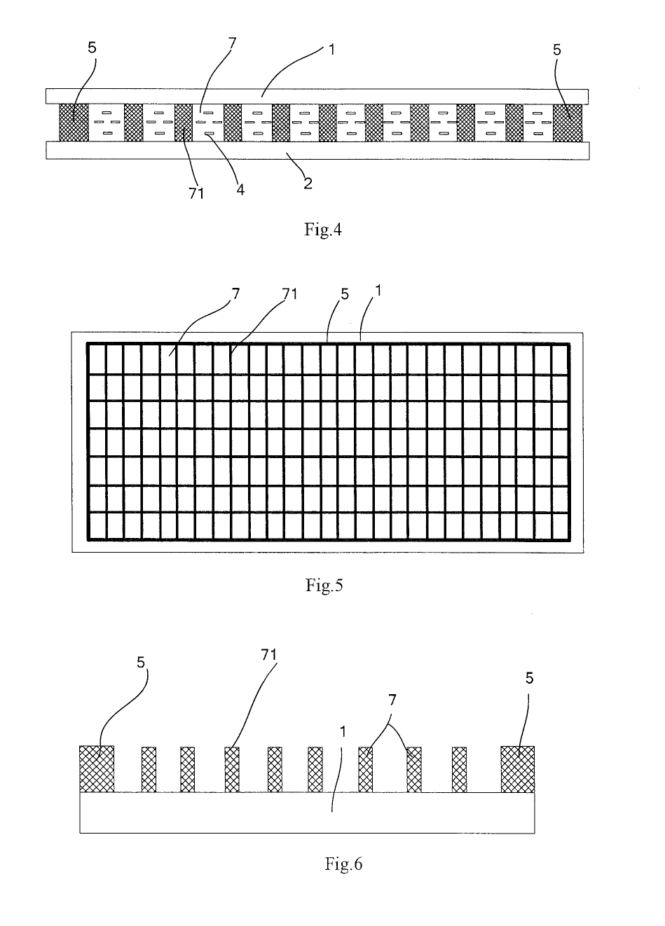

list of reference numerals:

1-color filter substrate; 2-array substrate; 3-spacer; 4-liquid crystal material; 41-liquid crystal outside the electrode region; 42-liquid crystal inside the electrode region; 5-sealing frame; 6-black matrix; 7-liquid crystal box; 71-pixel frame; 8-common electrode; 9-pixel electrode; 10-red sub-filter element; 11-green sub-filter element; 12-resin film layer

### DETAILED DESCRIPTION OF PREFERRED EMBODIMENTS OF THE INVENTION

Exemplary embodiments of the present disclosure will be described hereinafter in detail with reference to the accompanying drawings. The present disclosure may, however, be embodied in many different forms and should not be construed as being limited to the embodiments set forth herein; rather, these embodiments are provided so that the present disclosure will be thorough and complete, and will fully convey the concept of the disclosure to those skilled in the art.

As shown in FIGS. 4 and 5, the exemplary embodiment of present invention provides a flexible liquid crystal panel which comprises a color filter substrate 1, an array substrate 2 and a liquid crystal layer which is interposed between the color filter substrate 1 and the array substrate 2. The color filter substrate 1 includes a color filter layer which has a plurality of sub-filter elements and a black matrix which separates the plurality of sub-filter elements, wherein the liquid crystal layer comprises a plurality of separated liquid crystal boxes 7 which are enclosed by sealing frames, and each of the liquid crystal box 7 is arranged in correspondence with at least one (which means one or more than one) sub-filter element. The sealing frames forms the frames of the crystal boxes. The material of the sealing frame may be acrylic resin, silicone rubber etc. In order to save the material, as shown in FIG. 4, over the whole liquid crystal panel, the frames of the liquid crystal boxes at the edges (periphery) of the liquid crystal panel is relatively wider, which form box-assembling frames 5, while the frames of the liquid crystal boxes inside the liquid crystal panel is relatively narrower, which form pixel frames 71.

In an optional embodiment of present invention, in order to ensure the display effect of the flexible liquid crystal panel, further, each liquid crystal box 7 is arranged in correspondence with only one sub-filter element. Specifically, the planar pattern of the liquid crystal boxes 7 is same as that of the black matrix, such that the frames of the respective liquid crystal boxes 7 align with the positions of frames of the black matrix. The frames of the liquid crystal boxes of the embodiment align with the frames of the black matrix, which can both achieve a function of supporting as a spacer, and avoid affecting light transmission of the respective sub-filter elements.

Below, a method of manufacturing a flexible liquid crystal panel illustrated in FIG. 4 is described. The method specifically comprises steps of

S1, forming a color filter substrate 1 and an array substrate 2, respectively,

specifically, forming a plurality of sub-filter elements and a black matrix which separate the plurality of sub-filter elements on a base substrate by a first patterning process. The first patterning process is a process known in the art, which mainly includes exposure, developing and etching processes, and will not be discussed here in detail.

S2, forming a plurality of separated liquid crystal boxes 7 on the array substrate 2 or the color filter substrate 1 enclosed by sealing frames, and arranging each liquid crystal box 7 in correspondence with at least one sub-filter element.

Because the frames of the liquid crystal boxes should be aligned with the black matrix of the color filter substrate, in order to simplify the manufacturing process and improve the accuracy of aligning, the liquid crystal boxes can be formed on the color filter substrate 1. As shown in FIG. 6, specifically, at first, forming a sealing frame film layer on the color filter substrate 1 by means of coating, spraying or sputtering; then forming a pattern of multiple separated liquid crystal boxes 7 in the sealing frame film layer by a second patterning process with the frames of the liquid crystal boxes being in correspondence with the frames defining the black matrix. The second patterning process is same as the first patterning process, which mainly includes exposure, developing and etching process.

In order to further avoid the light leakage of the liquid crystal panel, each liquid crystal box can be arranged in correspondence with only one sub-filter element.

S3, injecting liquid crystal material 4 into each of the liquid crystal boxes after the liquid crystal boxes 7 are formed, as shown in FIG. 7.

Specifically, because the liquid crystal box which is arranged in correspondence with one or more sub-filter elements is small in size, to quantify and position liquid crystal material precisely, the ink jet printing process is employed in the present embodiment to precisely inject the liquid crystal material into each of the liquid crystal boxes.

S4, assembling the color filter substrate 1 and the array substrate 2, after the liquid crystal material 4 is injected into the liquid crystal boxes 7.

Specifically, performing a hot pressing process on the liquid crystal box to melt the sealing frame, pressing the array substrate 2 towards the color filter substrate 1 to press the sealing frame so as to bond the color filter substrate and the array substrate by the sealing frame to form a liquid crystal panel as shown in FIG. 4.

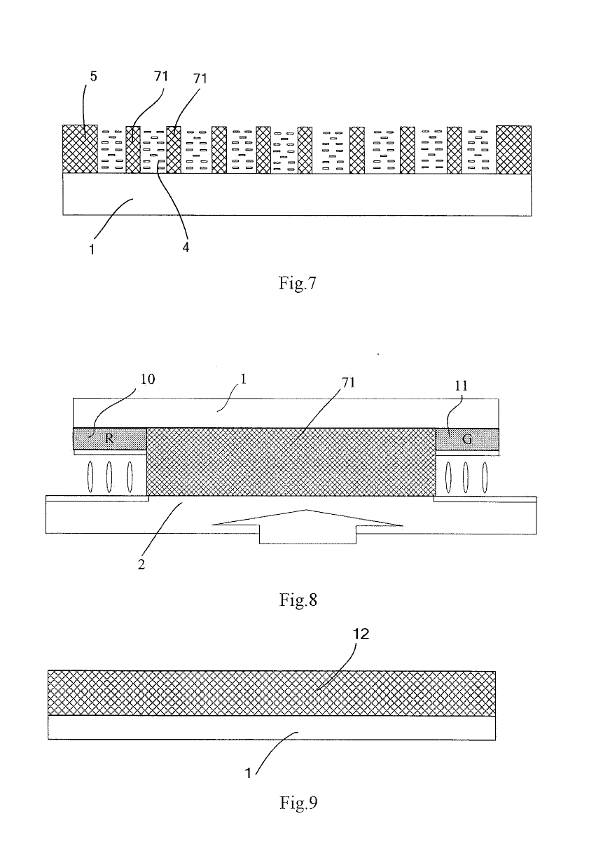

FIG. 8 illustrates schematically the structure of a flexible liquid crystal panel according to another embodiment of the present invention. The difference between the embodiment shown in FIG. 8 and the preceding embodiment mainly lies in that the color filter layer is not provided with a black matrix, and only comprises a plurality of sub-filter elements instead. Correspondingly, the liquid crystal boxes 7 of the present embodiment is defined by the sealing frame which comprises a black light-blocking material, and each of the liquid crystal boxes 7 is arranged in correspondence with at least one (which means one or more than one) sub-filter element, the frames of the liquid crystal boxes are provided between the plurality of sub-filter elements. For example, as shown in FIG. 8, the pixel frame 71 is provided between the red sub-filter element 10 and the green sub-filter element 11. The material of the sealing frame may be acrylic resin, silicone rubber etc., which comprises a black light-blocking material. The black light-blocking may be carbon powder etc.

In an optional embodiment of the present invention, in order to further ensure the display effect of the flexible liquid crystal panel, each liquid crystal box 7 is arranged in correspondence with only one sub-filter element, the frames of the liquid crystal boxes are provided between the plurality of sub-filter elements, and the liquid crystal box is defined by the sealing frame which comprises a black light-blocking material, and the sealing frame can have the function of the black matrix and the spacer to separate respective sub-filter elements and support the color filter substrate and the array substrate, achieving a function of supporting and avoiding affecting light transmission of respective sub-filter elements.

The manufacturing method of the flexible liquid crystal panel of the embodiment in FIG. 8, is specifically described as follows:

S10, forming a color filter substrate and an array substrate respectively.

Specifically, forming a pattern of a plurality of sub-filter elements on a base substrate by a first patterning process. The first patterning process is a process known in the art, which mainly includes exposure, developing and etching process. For example, in order to forma RGB color filter layer, forming a red filter coating on the base substrate at first and then performing exposure and developing using a mask with a pattern so as to form red sub-filter elements 10, repeating similar steps to obtain green sub-filter elements 11 and blue sub-filter elements.

S20, forming a pattern of the plurality of separated liquid crystal boxes on the array substrate 2 or the color filter substrate 1 by the sealing frames, and arranging each liquid crystal box in correspondence with at least one sub-filter element.

Because the frames of the liquid crystal boxes should be aligned with the intervals between the plurality of the sub-filter elements, in order to improve the accuracy of aligning, simplify the manufacture process and provide the process precision, one can choose forming the liquid crystal boxes on the color filter substrate.

Specifically, after forming a plurality of sub-filter elements, blending black light-blocking material and material for the sealing frame, and forming a sealing frame film layer 12 on the color filter substrate 1 with the plurality of sub-filter elements, as shown in FIG. 9; performing an exposure and developing processes on a back side by using the color filter layer, on which is formed the sub-filter elements, as a mask so as to obtain a pattern of multiple separated liquid crystal boxes, the frames of the liquid crystal boxes are located between the plurality of the sub-filter elements.

In order to further avoid the light leakage of the liquid crystal panel, each liquid crystal box can be arranged in correspondence with only one sub-filter element.

S30, injecting the liquid crystal material into each of the liquid crystal boxes after the liquid crystal boxes are formed.

Specifically, because the liquid crystal box which is arranged in correspondence with one or more sub-filter elements is small in size, to quantify and position liquid crystal material precisely, the ink jet printing process is employed in the present embodiment to precisely inject the liquid crystal material into each of the liquid crystal boxes.

S40, assembling the color filter substrate and the array substrate, after the liquid crystal material is injected into the liquid crystal boxes.

Specifically, performing a hot pressing process on the liquid crystal box to melt the sealing frame, pressing the array substrate 2 towards the color filter substrate 1 to press the sealing frame, so as to bond the color filter substrate and the array substrate by the sealing frame to form a liquid crystal panel as shown in FIG. 4.

with the flexible liquid crystal panel and the manufacture method thereof according to embodiments of the present invention, there are a plurality of separated liquid crystal boxes in the liquid crystal layer, each liquid crystal box is arranged in correspondence with at least one sub-filter element, which completely solves the problem of the interference between the sub-filter elements at the time of flexible display, so that the liquid crystal panel can display as normal when being bended without light leakage, improving display effect of the flexible liquid crystal panel. In some embodiments, the liquid crystal boxes are made of the sealing frames which are added with black light-blocking material, which can have the functions of both the black matrix and the spacer, and are used to separate respective sub-filter elements and support the color filter substrate and the array substrate, achieving a function of supporting, and avoiding affecting light transmission of respective sub-filter elements.

Although several exemplary embodiments have been shown and described, it would be appreciated by those skilled in the art that various changes or modifications may be made in these embodiments without departing from the principles and spirit of the disclosure, the scope of which is defined in the claims and their equivalents.

1. A flexible liquid crystal panel, comprising
a color filter substrate which includes a color filter layer comprising plurality of sub-filter elements;
an array substrate; and
a liquid crystal layer interposed between the color filter substrate and the array substrate,
wherein:
the liquid crystal layer comprises a plurality of separated liquid crystal boxes defined by sealing frames, and each of the liquid crystal boxes is arranged in correspondence with at least one sub-filter element, the sealing frames form the frames of the liquid crystal boxes.

2. The flexible liquid crystal panel according to claim 1,
wherein the color filter layer of the color filter substrate further comprises a black matrix which separates the plurality of sub-filter elements; and
the positions of the frames of the liquid crystal boxes correspond to those of the black matrix.

3. The flexible liquid crystal panel according to claim 2,
wherein the sealing frame comprises a black light-blocking material.

4. The flexible liquid crystal panel according to claim 3,
wherein the frame of each liquid crystal box corresponds to the position of the black matrix, and a planar pattern of the liquid crystal boxes is the same as that of the black matrix.

5. The flexible liquid crystal panel according to claim 1,
wherein the sealing frame comprises a black light-blocking material and forms a black matrix which separates the plurality of the sub-filter elements.

6. The flexible liquid crystal panel according to claim 1,
wherein the sealing frames form spacers between the color filter substrate and the array substrate.

7. The flexible liquid crystal panel according to claim 1,
wherein the sealing frames at the edges of the flexible liquid crystal panel form box-assembling frames, while the sealing frames inside the flexible crystal panel form pixel frames, the box-assembling frame has a width larger than that of the pixel frame.

8. A method of manufacturing a flexible liquid crystal panel, comprising steps of
defining a plurality of separated liquid crystal boxes on a color filter substrate or an array substrate and forming frames of the liquid crystal boxes with sealing frames, each liquid crystal box being arranged in correspondence with at least one sub-filter element;
injecting a liquid crystal material into the liquid crystal boxes;
assembling the color filter substrate and the array substrate after the liquid crystal material is injected into the liquid crystal boxes.

9. The method according to claim 8,
wherein defining a plurality of separated liquid crystal boxes on a color filter substrate by a sealing frame, comprising steps of
forming a sealing frame film layer on the color filter substrate;
forming a pattern of the frames of the plurality of the liquid crystal boxes in the sealing frame film layer by a patterning process, the pattern of the frame of each liquid crystal box being arranged in correspondence with at least one sub-filter element.

10. The method according to claim 9,
wherein a color filter layer is provided on the color filter substrate, the color filter layer comprises multiple sub-filter elements and a black matrix which separate the multiple sub-filter elements; and
the pattern of the frames of the plurality of the liquid crystal boxes is provided on the color filter layer and the frames of the plurality of the liquid crystal boxes are arranged along the pattern of the black matrix correspondingly.

11. The method according to claim 10,
wherein the sealing frame comprises a black light-blocking material.

12. The method according to claim 9,
wherein a color filter layer which comprises multiple sub-filter elements is provided on the color filter substrate;
the sealing frame comprises a black light-blocking material; and
the frames of the liquid crystal boxes form a black matrix which separates the sub-filter elements.

13. The method according to claim 8,
wherein defining a plurality of separated liquid crystal boxes on the array substrate by the sealing frames, comprises steps of:
forming a sealing frame film layer on the array substrate;
forming a pattern of the frames of the plurality of the liquid crystal boxes in the sealing frame film layer with a patterning process, a pattern of the frames of each liquid crystal boxes is arranged in correspondence with the intervals between the sub-filter elements.

14. The method according to claim 13,
wherein the sealing frame comprises a black light-blocking material.

15. The method according to claim 14,
wherein the frames of the liquid crystal boxes form a black matrix which separates the sub-filter elements.

16. The method according to claim 8,
wherein the step of assembling the color filter substrate and the array substrate comprises:
performing a hot pressing process on the liquid crystal box to bond the color filter substrate and the array substrate together so as to form a liquid crystal panel.

17. The method according to claim 8,
wherein the step of injecting the liquid crystal material into the liquid crystal box comprises:
injecting the liquid crystal material into each liquid crystal box with an ink jet printing process.
